(19) United States
(12) Patent Application Publication
(10) Pub. No.: US 2022/0354084 A1
(43) Pub. Date: Nov. 10, 2022

(54) A Flooring System Support Unit In A Modular Flooring System for Construction of a Piggery with A Plurality of Pigsties With Underlying Manure Channels

(71) Applicant: IKADAN SYSTEM A/S, Ikast (DK)

(72) Inventor: Bjarne KONGSGAARD, Silkeborg (DK)

(73) Assignee: IKADAN SYSTEM A/S, Ikast (DK)

(21) Appl. No.: 17/763,068

(22) PCT Filed: Sep. 23, 2020
(86) PCT No.: PCT/DK2020/050261

§ 371 Date: Mar. 23, 2022

(30) Foreign Application Priority Data
Sep. 24, 2019 (DK) PA201970586

(51) Int. Cl. A01K 1/01; A01K 1/02

(52) U.S. Cl. CPC A01K 1/01; A01K 1/02

(57) ABSTRACT

A modular flooring system for construction of a piggery with a plurality of pigsties with underlying manure channels, wherein the flooring system includes one or more flooring system support units. Each flooring system support unit including a top part with a flooring support surface and an opposing underside and a bottom part with a support side and an opposing topside, and a middle part. The middle part including at least two interconnecting support legs extending between, and connecting the top part with the bottom part. The modular flooring system including one or more gratings for being mounted on and extend between top parts of the flooring system support units and one or more watertight manure channel membranes.

### TECHNICAL FIELD

The present invention relates to a modular flooring system for construction of a piggery with a plurality of pigsties with underlying manure channels, a flooring system support unit for construction of a piggery, a piggery wherein the piggery is at least partly constructed from a modular flooring system, and use of a flooring system support unit for construction of a piggery.

### BACKGROUND ART

Piggeries are usually constructed with slatted floors and underlying manure channels made of concrete, foundation blocks and concrete elements, which are cast together on the site. The concrete floor and walls a used to both as a separate between multiple pigsties and as a carrying element for the gratings on which the pigs walk and lay. Such a solution with base foundations and concrete channels is costly and labour-intensive and it can be very difficult to remove or replace if it is desired to change the method of working or perhaps stop the operation. Further, it has to be assured that the area of between the walls is not surpassing the amount of manure, which can be sluiced through the vacuum manure system placed under the floor of the pigsty.

### SUMMARY

It is an object of the present invention to provide a modular system for construction of piggeries with underlying manure channels without the above-mentioned disadvantages of solutions known within the art.

Further, it is an object of the present invention to provide a cheaper, less time consuming and environmental solution to the above-mentioned problems.

According to a first aspect there is provided a modular flooring system for construction of a piggery with a plurality of pigsties with underlying manure channels, wherein the flooring system comprises one or more flooring system support units each comprising a top part with a flooring support surface and an opposing underside; a bottom part with a support side and an opposing topside, and a middle part comprising at least two interconnecting support legs extending between, and connecting the top part with the bottom part, wherein the support side of the bottom part is placed directly on a supporting floor surface, such as a concrete floor, a compressed bed of sand on the concrete floor, or a watertight manure channel membrane placed between the compressed bed of sand and the support side of the bottom part; one or more gratings for being mounted on and extend between top parts of the flooring system support units, wherein the one or more gratings is configured for providing a support floor for carrying one or more pigs in the pigsties; and one or more watertight manure channel membranes configured to ensure imperviousness of sides, bottom, and/or ends of one or more manure channel defined in a space between the one or more watertight manure channel membranes and the one or more gratings.

Such a modular system allows for a much cheaper and less labour-intensive construction of a piggery, among other things because it is not necessary to cast a bottom for the manure channels, since the flooring system support units can simply be placed on a compressed bed of sand.

Further, such a solution have a large surface of the support side of the bottom part. Such a surface minimises the pressure on a watertight manure channel membrane, hereby minimising the risk of tearing the watertight manure channel membrane. The flooring system support units also function as a bearing unite for the gratings, or flooring as a whole if another floor then gratings is used in the pigsty.

If the support floor is a watertight manure channel membrane the bottom part may be sealed to the surface using a plastic or plastic-like material.

It is further envisioned to keep a high degree of hygiene along the pigsty's sidewalls and to minimise the amount of adhesion/attachment and stiffening of the pigsty's sidewalls.

If the support side of the bottom part is placed directly on a concrete floor at may be advantageous to bolt it to the floor for added stiffness and increased durability. However, the width of the bottom part, especially the support side of the bottom part allows it to be placed directly on a watertight manure channel membrane floor with minimised risk of damage to the membrane.

According to a second aspect there is provided a flooring system support unit in a piggery with a plurality of pigsties with underlying manure channels wherein each of the flooring system support units comprises a top part with a flooring support surface and an opposing underside; a bottom part with a support side and an opposing topside; and a middle part comprising at least two interconnecting support legs extending between, and connecting the top part with the bottom part, wherein the support side of the bottom part is placed directly on a supporting floor surface, such as a concrete floor, a compressed bed of sand on the concrete floor, or a watertight manure channel membrane placed between the compressed bed of sand and the support side of the bottom part.

According to a third aspect there is provided a piggery wherein the piggery is at least partly constructed from a modular flooring system comprising one or more flooring system support units each comprising a top part with a flooring support surface and an opposing underside; a bottom part with a support side and an opposing topside, and a middle part comprising at least two interconnecting support legs extending between, and connecting the top part with the bottom part, wherein the support side of the bottom part is placed directly on a supporting floor surface, such as a concrete floor, a compressed bed of sand on the concrete floor, or a watertight manure channel membrane placed between the compressed bed of sand and the support side of the bottom part; one or more gratings for being mounted on and extend between top parts of the flooring system support units, wherein the one or more gratings is configured for providing a support floor for carrying one or more pigs in the pigsties; and one or more watertight manure channel membranes configured to ensure imperviousness of sides, bottom, and/or ends of one or more manure channel defined in a space between the one or more watertight manure channel membranes and the one or more gratings.

According to a fourth aspect there is provided a use of a flooring system support unit for construction of a piggery with a plurality of pigsties with underlying manure channels, wherein each of the flooring system support units comprises a top part with a flooring support surface and an opposing underside; a bottom part with a support side and an opposing topside; and a middle part comprising at least two interconnecting support legs extending between, and connecting the top part with the bottom part, wherein the support side of the bottom part is placed directly on a supporting floor surface, such as a concrete floor, a compressed bed of sand on the concrete floor, or a watertight manure channel membrane placed between the compressed bed of sand and the support side of the bottom part.

In one or more embodiments, the flooring support surface of the top part of the flooring system support unit comprises furrows or recesses and/or a protrusion at or near one or more sides on the flooring support surface for mounting the one or more gratings.

By making furrows in the top part, special gratings can be constructed which fits into these furrows, and hereby a click system between the flooring system support units and the gratings may be obtained, making it easier to mount and therefore to construct the piggery with multiple pigsties.

In one or more embodiments, the one or more flooring system support units are made of plastic, metal, concrete, fiberglass or combinations hereof.

By using the above material it is possible to make a lighter module with less material, e.g. it may comprise holes in the structure, hereby avoiding a complete filled and closed concrete element.

In one or more embodiments, the one or more flooring system support units are made of injection moulded plastic.

The use of injection moulded plastic for the one or more flooring system support units results in a fine combination of low weight and high strength.

In one or more embodiments, the modular flooring system further comprises a plurality of carrier profiles for being mounted perpendicular between two flooring system support units, or perpendicular between the flooring system support unit and another partition or wall in the piggery.

Such carrier profiles function as a stiffening support to ensure the correct distance between neighbouring flooring system support units and minimises the risk of them toppling or moving during the construction of the modular system. Furthermore, together with the gratings, these carrier profiles ensure that the flooring system support units are not displaced by the pressure from the manure if there is a full manure channel on one side of the flooring system support units and an empty manure channel on the other side.

In one or more embodiments, the at least two interconnecting support legs comprises an adjustment system for adjusting the distance between the opposing underside of the top part with the opposing topside of the bottom part.

If the flooring system support units are fabricated in one or two standard sizes, it may be advantageous to be able to adjust the height of the gratings in the pigsty to make room for more or less manure in the created manure channel.

The adjustment system may in aspects of the present disclosure comprise e.g. a threaded connection system and/or a latch/notch system.

In one or more embodiments, the means for adjusting is means for levelling the flooring support surface of the top part if the bottom part is placed on an uneven concrete floor, compressed bed of sand, or watertight manure channel membrane.

If the underlying floor is uneven it may be advantageous to have some build in system, which can level the flooring support surface to obtain a levelled surface to mount the gratings on, hereby obtaining a levelled floor for the pigs.

In one or more embodiments, the top part of the flooring system support unit further comprises one or more through-openings extending all the way through the top part from the flooring support surface to the opposing underside. These through-openings are configured to guide manure towards the manure channel.

By creating openings or slits at the top part of the flooring system support unit it is possible to ensure a higher hygiene level in the pigsty, as the manure along the walls is not stacked but will go down into the manure channel through the through-openings in the top part.

In one or more embodiments, the top part of the flooring system support unit further comprises means, such as one or more recesses and/or protrusions for attaching one or more wall elements designed to constitute partition walls of the pigsty.

If the flooring system support units comprise means for attaching side walls, the may serve as not only support for the gratings and a way to create multiple manure channels, but they can also serve as building blocks for creating the upper sidewalls to dived the piggery into multiple pigsties.

In one or more embodiments, the means for attaching one or more wall elements is a furrow extending from one end of the flooring support surface of the top part to the opposite end of the flooring support surface.

In one or more embodiments, the means for attaching one or more wall elements is at least two flanges with a distance between the at least two flanges corresponding to the thickness of the wall elements designed to constitute the pigsty partitions, wherein the flanges are attached to the top part of the flooring system support unit and extends outwards from the flooring support surface.

In one or more embodiments, the bottom part further comprises an insert attached to the opposing topside of the bottom part and wherein the insert extends outwards from the opposing topside of the bottom part.

By adding an insert to the bottom part of the flooring system support unit and wherein this insert extends outwards from the opposing topside of the bottom part it is ensured that the last part of the manure has easy access to the manure channel and hereby also to the vacuum manure system placed under the floor of the pigsty.

In one or more embodiments, the insert attached to the opposing topside of the bottom part extends no more than half way between the opposing topside of the bottom part and the opposing underside of the top part when the opposing underside of the top part and the opposing topside of the bottom part is connected through the at least two interconnecting support legs extending between the opposing underside of the top part and the opposing topside of the bottom part.

By keeping the insert attached to the opposing topside of the bottom part to only extend half way between the opposing topside of the bottom part and the opposing underside of the top part it is ensured that if one manure channel is filling up, it may be transferred over to the neighbouring manure channel, and by not filling the manure channel to more than half the volume, the manures side pressure on the inserted attachment is minimised.

In one or more embodiments, the insert attached to the opposing topside of the bottom part is triangular shaped with one of the sides of the triangle attached along the opposing topside of the bottom part.

By having a triangular shape, the manure dripping down from the gratings is flowing/guided to the manure channel

In one or more embodiments, the insert attached to the opposing topside of the bottom part is covering at least 50% of the outer surface of the opposing topside of the bottom part.

By covering at least 50% of the opposing topside of the bottom part with the inserted attachment may optimise the amount of manure which is trapped in the bottom part of the flooring systems support unit, and instead be guided toward the manure channel and the vacuum manure system placed under the floor of the pigsty.

In one or more embodiments, the insert attached to the opposing topside of the bottom part is covering at least 60% of the outer surface of the opposing topside of the bottom part.

In one or more embodiments, the insert attached to the opposing topside of the bottom part is covering at least 70% of the outer surface of the opposing topside of the bottom part.

In one or more embodiments, the insert attached to the opposing topside of the bottom part is covering at least 80% of the outer surface of the opposing topside of the bottom part

In one or more embodiments, the top part and/or the bottom part of the one or more flooring system support units comprises an interlocking system so that the one or more flooring system support units is attached to each other in a side to side manor, hereby obtaining an extended, even flooring support surface extending from one top part to another.

By making a part of the top part able to stack on another part of an adjacent top part, a click system may be obtained in which a sequence of flooring system support units can be attached to one and another via this click mechanism and hereby obtain a levelled extended flooring support surface.

In one or more embodiments, the support side of the bottom part and the flooring support surface of the top part are of equal surface size.

In one or more embodiments, the opposing topside of the bottom part and the opposing underside of the top part are of equal surface size.

In one or more embodiments, the bottom part and the top part are square or essentially square shaped.

In one or more embodiments, the bottom part and the top part are equal in shape and size.

By making the top and bottom equal in shape and size may be advantageous as one moulding process can be used to create both parts, or two of the same part can serve as both the bottom part and the top part.

In one or more embodiments, the support side of the bottom part has a two-dimensional surface area, of an outer surface in direct contact with supporting floor surface at least twice the total two-dimensional surface area of the at least two interconnecting support legs if the two-dimensional surface area of the at least two interconnecting support legs is measured where said two dimensional surface area is largest.

The two-dimensional surface area of the support side of the bottom side has to be large enough to create a solid support for the gratings. Additionally, the size has to be large to minimise the pressure on a watertight manure channel membrane, hereby minimising the risk of tearing the membrane.

In one or more embodiments, the support side of the bottom part has a two-dimensional surface area, of an outer surface in direct contact with supporting floor surface at least triple the total two-dimensional surface area of the at least two interconnecting support legs if the two-dimensional surface area of the at least two interconnecting support legs is measured where said two dimensional surface area is largest.

In one or more embodiments, the support side of the bottom part has a two-dimensional surface area, of an outer surface in direct contact with supporting floor surface at least quadruple the total two-dimensional surface area of the at least two interconnecting support legs if the two-dimensional surface area of the at least two interconnecting support legs is measured where said two dimensional surface area is largest.

In one or more embodiments, the support side of the bottom part has a two-dimensional surface area of at least 200 cm², such as at least at least 300 cm², such as at least at least 400 cm², such as at least at least 500 cm², such as at least at least 600 cm², such as at least at least 700 cm², such as at least at least 800 cm², such as at least at least 900 cm².

In one or more embodiments, the support side of the bottom part has a two-dimensional surface area of less than 10.000 cm², such as less than 9.000 cm², such as less than 8.000 cm², such as less than 7.000 cm², such as less than 6.000 cm², such as less than 5.000 cm², such as less than 4.000 cm², such as less than 3.000 cm².

In one or more embodiments, the support side of the bottom part has a two-dimensional surface area is between 200 and 10.000 cm², such between 300 and 9.000 cm², such between 400 and 8.000 cm², such between 500 and 7.000 cm², such between 600 and 6.000 cm², such between 700 and 5.000 cm², such between 800 and 4.000 cm², such between 900 and 3.000 cm².

In one or more embodiments, the at least two interconnecting support legs are detachable and attachable to both the top part and the bottom part of the one or more flooring system support units.

If the legs can be detached and again attached to the top and bottom part, the three parts can be provided as an assembly set, which might lower the size of cargo when it has to be transported.

In one or more embodiments, the one or more flooring system support units is made in one piece the modular comprises both the top part, bottom part, and the at least two interconnecting support legs.

In one or more embodiments, the at least two interconnecting support legs are divided in two substantially similar sized legs each, hereby obtaining at least four interconnecting half-legs.

In one or more embodiments, the one or more flooring system support units is made from two pieces, wherein a first piece comprises the top part and at least two interconnecting half-legs and wherein a second piece comprises the bottom part and at least two interconnecting half-legs.

In one or more embodiments, the first piece comprises holes in the top part corresponding to the shape of the at least two interconnecting half-legs so the first piece is stackable with another first piece.

If the pieces are stackable is lowers the volume needed when transported.

In one or more embodiments, the second piece comprises holes in the bottom part corresponding to the shape of the at least two interconnecting half-legs so the second piece is stackable with another second piece.

In one or more embodiments, the first piece and the second piece are of similar shape and size.

In one or more embodiments, the holes are filed with concrete.

Making the two pieces of similar shape and size may be advantageous as one moulding process can be used to create both pieces, or two of the same pieces can serve as both the bottom piece and the top piece.

In one or more embodiments, the first piece and the second piece is stackable with each other.

Again, if the pieces are stackable is lowers the volume needed when transported.

In one or more embodiments, an adjustment system for adjusting the distance between the opposing underside of the top part with the opposing topside of the bottom part is fitted between one or more of the at least two interconnecting half-legs of the first piece and the at least two interconnecting half-legs of the second piece.

If the flooring system support units are fabricated in one or two standard sizes, it may be advantageous to be able to adjust the height of the gratings in the pigsty to make room for more or less manure in the created manure channel. Further, if the underlying floor is uneven it may be advantageous to have some build in system, which can level the flooring support surface to obtain a levelled surface to mount the gratings on, hereby obtaining a levelled floor for the pigs.

In one or more embodiments, the one or more flooring system support units are placed within a piggery in connection with a reconstruction of this, for instance on an existing concrete bed or on a compressed bed of sand on top thereof, or on a watertight manure channel membrane placed atop of the compressed bed of sand.

In this way, a significant part of the costs related to reconstruction of a piggery can be saved by using the modular system according to the present invention.

In one or more embodiments, the one or more flooring system support units are supported by point foundations, for instance under the ends of each of the one or more flooring system support units and under the middle of each of the one or more flooring system support units.

Effects and features of the second, third, and fourth aspects are to a large extent analogous to those described above in connection with the first aspect. Embodiments mentioned in relation to the first aspect are largely compatible with the second and third aspects.

The present invention will become apparent from the detailed description given below. The detailed description and specific examples disclose preferred embodiments of the invention by way of illustration only. Those skilled in the art understand from guidance in the detailed description that changes and modifications may be made within the scope of the invention.

Hence, it is to be understood that the herein disclosed invention is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above objects, as well as additional objects, features and advantages of the present invention will be more fully appreciated by reference to the following illustrative and non-limiting detailed description of example embodiments of the present invention, when taken in conjunction with the accompanying drawings.

FIG. 1 shows a side view of a piggery constructed with a plurality of pigsties according to an embodiment of the present disclosure.

FIG. 2 shows a top view of a flooring system support unit according to an embodiment of the present disclosure.

FIG. 3 shows a top view of a flooring system support unit according to another embodiment of the present disclosure.

FIG. 4 shows a top view of a flooring system support unit according to another embodiment of the present disclosure.

FIG. 5 shows a top view of a flooring system support unit further comprising mounted gratings according to an embodiment of the present disclosure.

FIG. 6 shows a top view of a flooring system support unit further comprising mounted gratings and a mounted wall element according to an embodiment of the present disclosure.

FIG. 7 shows a top view of two connected flooring system support units also comprising mounted gratings and a mounted wall element according to an embodiment of the present disclosure.

FIG. 8 shows a top view of a flooring system support unit according to another embodiment of the present disclosure.

FIG. 9 shows a top view of a flooring system support unit according to another embodiment of the present disclosure.

FIG. 10 shows an exploded view of a flooring system support unit according to an embodiment of the present disclosure.

### DETAILED DESCRIPTION

Various examples are described hereinafter with reference to the figures. It should also be noted that the figures are only intended to facilitate the description of the examples. They are not intended as an exhaustive description of the claimed invention or as a limitation on the scope of the claimed invention. In addition, an illustrated example needs not have all the aspects or advantages shown. An aspect or an advantage described in conjunction with a particular example is not necessarily limited to that example and can be practiced in any other examples even if not so illustrated, or if not so explicitly described.

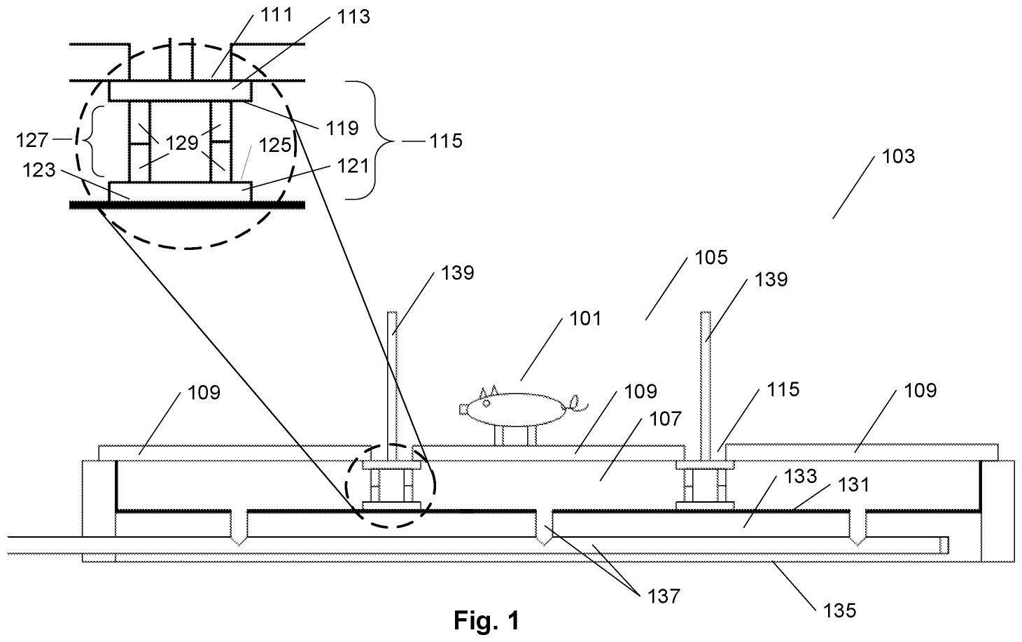

FIG. 1 shows a pig 101 in a piggery. The piggery is constructed with a plurality of pigsties 105, wherein only one is shown in the figure, the one comprising the pig 101. The pigsties have underlying manure channels 107. The flooring system in the figure is constructed of several gratings 109 that are mounted partially on a flooring support surface 111 of the top part 113 of a flooring system support unit 115. The gratings in the figure is also mounted on concrete pillars 117 making up part of the piggery 103. The flooring system support units 115 comprising a top part 113 with a flooring support surface 111 and an opposing underside 119, a bottom part 121 with a support side 123 and an opposing topside 125, and a middle part 127 comprising at least two interconnecting support legs 129 extending between, and connecting, the opposing underside 119 of the top part 113 with the opposing topside 125 of the bottom part 121, wherein the support side 123 of the bottom part 121 is placed on a watertight manure channel membrane 131 placed between a compressed bed of sand on a concrete floor 135 and the support side 123 of the bottom part 121. The manure channels 107 comprises a vacuum manure system/piping 137 placed under the gratings 109 of the pigsty 105. The figure further shows wall elements 139 attached to the top part 113 of the flooring system support units 115. These wall elements 139 can be removed of rearranged if needed.

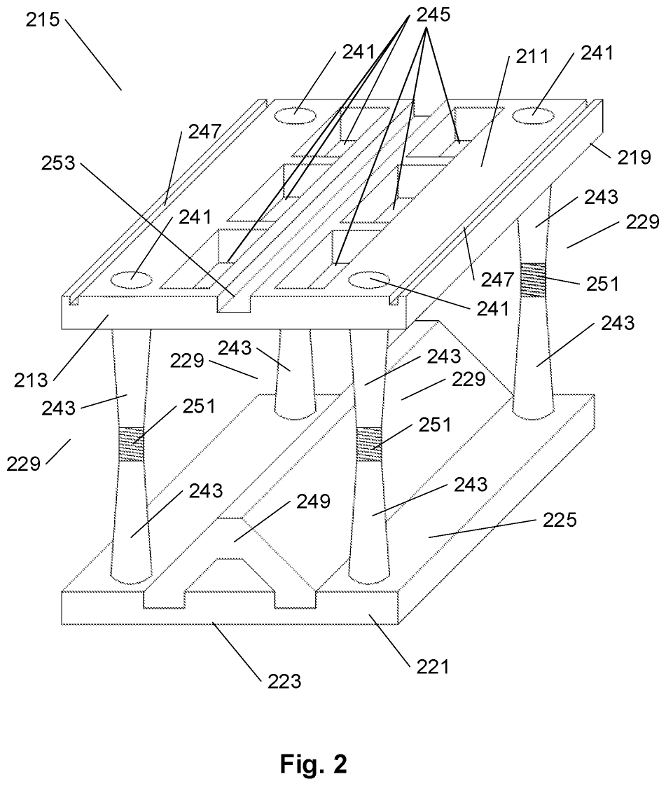

FIG. 2 shows a flooring system support unit 215 according to some embodiments of the present disclosure. The flooring system support unit 215 comprises holes 241 for stacking in the top part 213 of the flooring system support unit 215. These holes 241 for stacking are designed to fit in size to the interconnecting support legs 229, which in this embodiment is rigidly attached to the opposing underside 219 of the top part 213 of the flooring system support unit 215. The interconnected legs 229 are in this embodiment divided in two substantially similar sized legs each, called interconnecting half-legs 243. As these interconnecting half-legs 243 are rigidly attached to the opposing underside 219 of the top part 213 of the flooring system support unit 215, this makes up a first piece comprising the top part 213 and the interconnecting half-legs 243. The holes 241 for stacking is extended down into the interconnecting half-legs 243. As the holes 241 have a shape corresponding to the interconnecting half-legs 243, makes is possible to stack the first pieces on atop another. A similar principal is obtainable with the bottom part 221, if the interconnecting half-legs 243 fitted to the opposing topside 225 is rigidly connected and the bottom part 221 comprises holes (not shown) in a similar fashion as for the top part 213.

The interconnecting half-legs 243 can be made so that they can be adjusted in height if the floors are crooked. The embodiment of FIG. 2 further shows that the adjustment system for adjusting the distance 251 between the opposing underside 219 of the top part 213 with the opposing topside 225 of the bottom part 221 is a screw mechanism in which the distance in this embodiment can be adjusted between all four connecting regions of the interconnecting half-legs 243 (only three shown due to the view).

The flooring system support unit 215 is designed with a support side 223 of the bottom part 221 and a flat flooring support surface 211 of the top part 213, with through-openings 245 extending all the way through the top part 213 from the flooring support surface 211 to the opposing underside 219. This minimises the risk of build-up of manure along the walls and makes it easier to clean.

The flooring system support unit 215 is provided with furrows 247 near two sides on the flooring support surface 211 for mounting of gratings or footplates.

Since it may be desirable that manure channels have an area adapted to the drainage system/vacuum manure system, the bottom part 221 of the flooring system support unit 215 can be provided with an insert 249 attached to the opposing topside 225 of the bottom part 221. This insert 249 extends outwards from the opposing topside 225 of the bottom part 221, which ensures that the channel has the desired content hereby ensuring that the drainage system works optimally. In this particular embodiment the insert 249 is triangularly shaped with a blunt end pointing towards the top part 213.

The flooring system support unit 215 can be provided with click locks (not shown) so they are quick to assemble side-by-side. The low weight of plastic/composites makes it easy to handle and assemble the elements.

In the embodiment of FIG. 2, the flooring system support unit 215 is further provided with means for attaching 253 wall elements designed to constitute the pigsty partitions. The means for attaching 253 is in this particular embodiment a deep channel/furrow located in the middle of the flooring support surface 211 of the top part 213 extending from one side of the top part 213 to the opposing side.

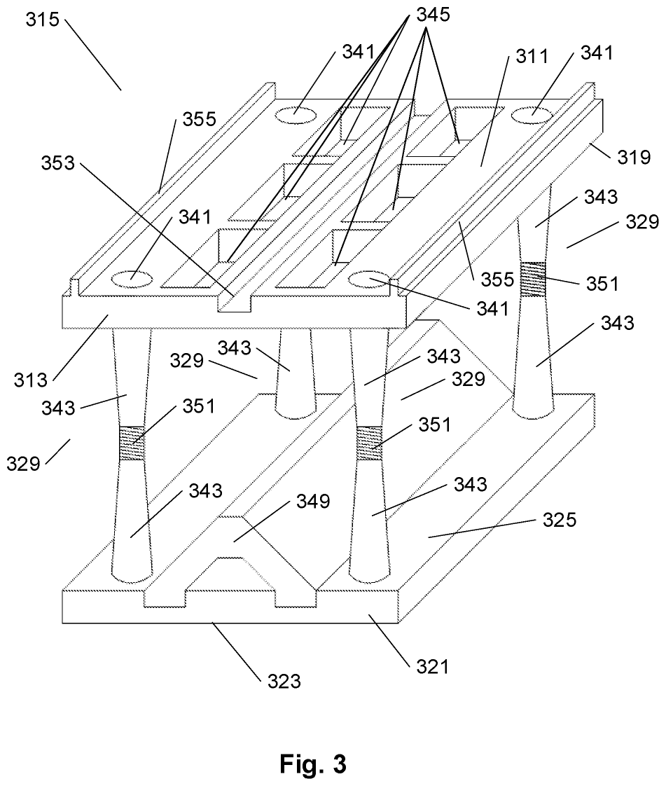

FIG. 3 shows a similar embodiment to the embodiment shown in FIG. 2, however, in the embodiment of FIG. 3 the flooring system support unit 315 is provided with protrusions 355 near two sides on the flooring support surface 311 for mounting of gratings or footplates.

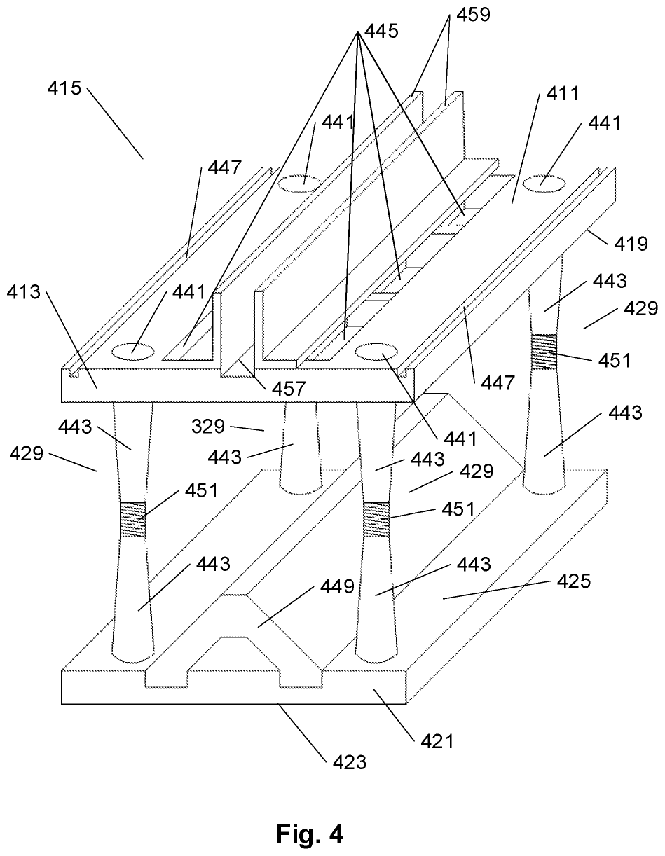

FIG. 4 shows a similar embodiment to the embodiment shown in FIG. 2, however, in the embodiment of FIG. 4 the flooring system support unit 415 is provided with means for attaching 457 wall elements designed to constitute the pigsty partitions in the form of two flanges 459 with a distance between the two flanges corresponding to the thickness of the wall elements designed to constitute the pigsty partitions. The flanges 459 are attached to the top part 413 of the flooring system support unit 415 and extends outwards from the flooring support surface 411 located in the middle of the flooring support surface 411 of the top part 413 extending from one side of the top part 413 to the opposing side.

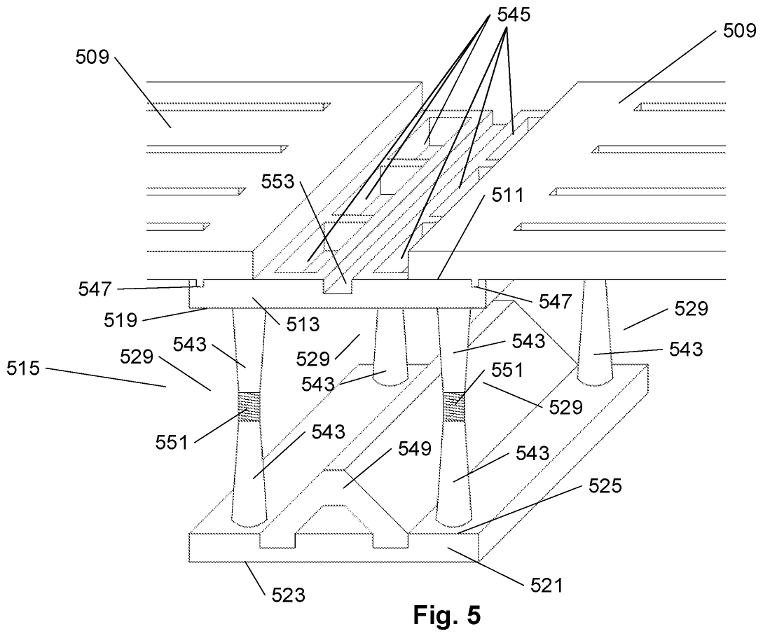

FIG. 5 shows a similar embodiment to the embodiment shown in FIG. 2, however, in the embodiment of FIG. 5 the furrows are mounted with gratings 509 fitting into these furrows.

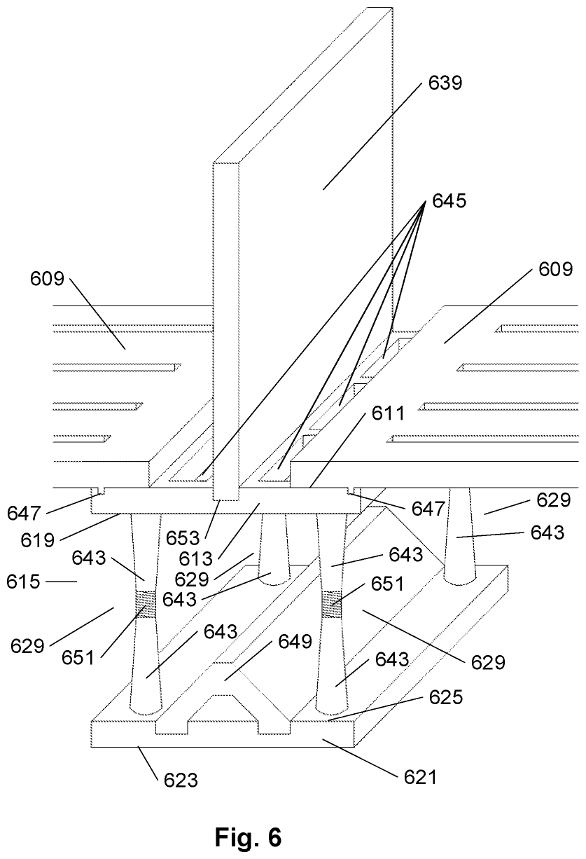

FIG. 6 shows a similar embodiment to the embodiment shown in FIG. 5, however, in the embodiment of FIG. 6 the deep channel/furrow located in the middle of the flooring support surface 611 of the top part 613 extending from one side of the top part 613 to the opposing side serving as the means for attaching 653 wall elements is attached to a wall element 639 as shown.

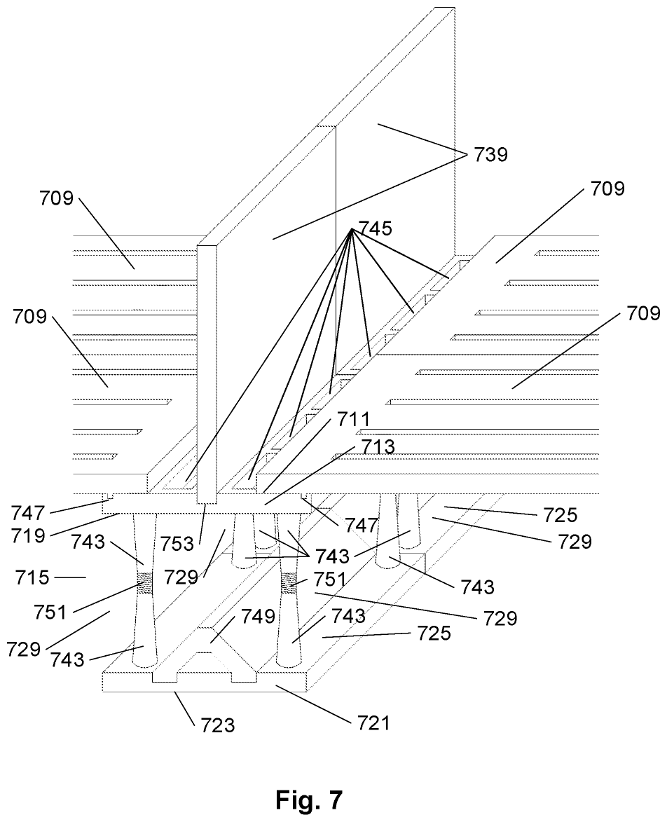

FIG. 7 shows a similar embodiment to the embodiment shown in FIG. 6, however, in the embodiment of FIG. 7 two flooring system support units 715 are connected an four gratings 709 are mounted on the flooring support surface 711. Further two wall elements 739 are attached to the deep channel/furrow located in the middle of the flooring support surface 711 of the top part 713 extending from one side of the top part 713 to the opposing side serving as the means for attaching 753 wall elements.

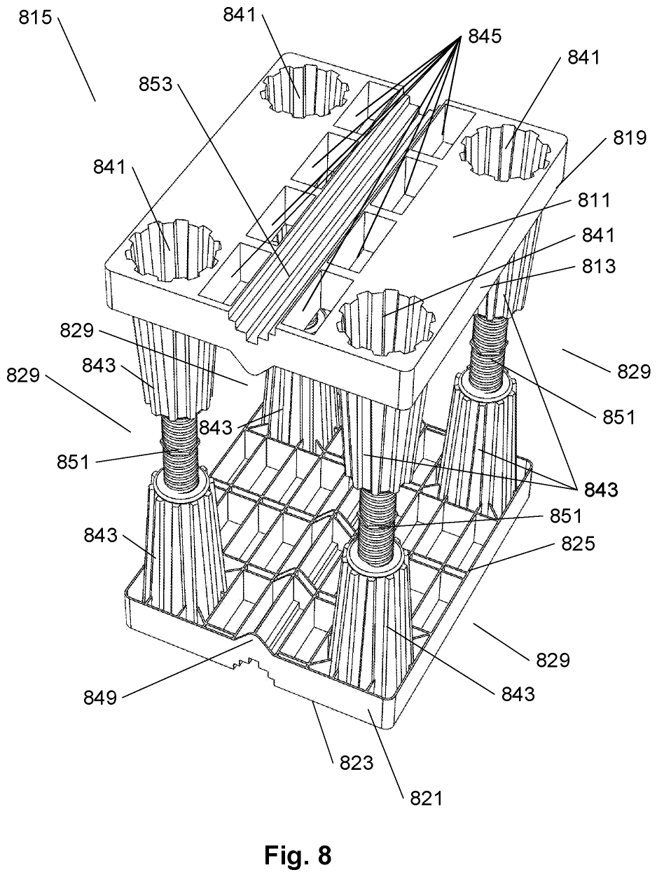

FIG. 8 shows an embodiment similar to the embodiment shown in FIG. 2, however, in the embodiment of FIG. 8 the flooring system support unit 815 comprises holes 841 for stacking in the top part 813 of the flooring system support unit 815 and interconnecting half-legs 843, which are tooth wheel shaped. Further, the provided means for attaching 853 wall elements is stepwise narrowed in width as the channel/furrow is stepwise increased in depth. Even further, the bottom part 821 is made of a web of interconnecting walls creating a grid structure with openings, hereby creating a lightweight bottom part 821 in comparison to a bottom part made of solid material all the way through. It is also envisioned to construct the top part 813 in a similar fashion. Further, the insert 849 attached to the opposing topside 825 of the bottom part 821 is in this embodiment constructed in connection with the bottom part 821 making up one piece. Lastly, the bottom part 821 and the top part 813 are identical in this specific embodiment.

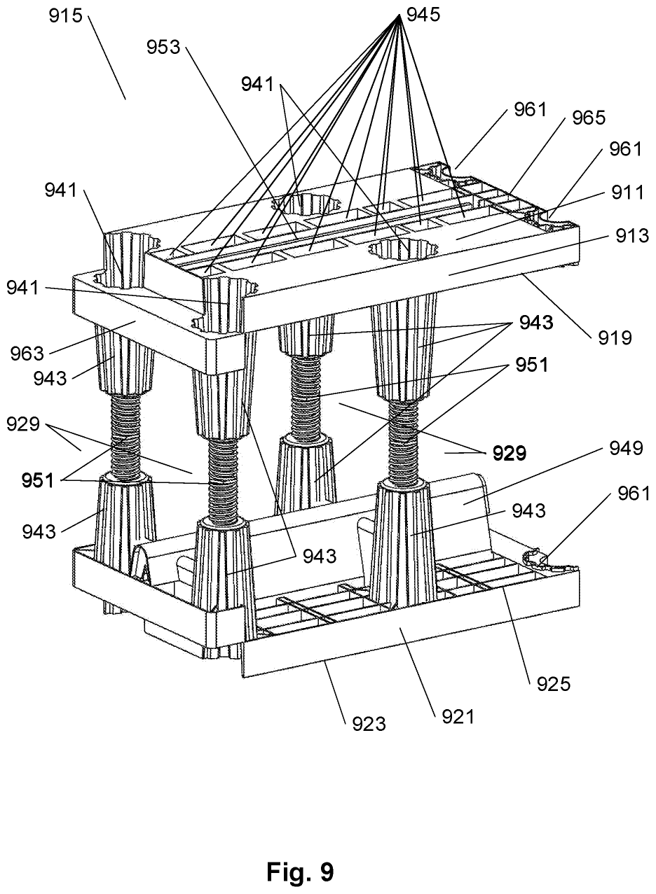

FIG. 9 shows an embodiment of the present disclosure similar to the embodiment of FIG. 8, however, in the embodiment of FIG. 9 the top part 913 and the bottom part 921 are extended to comprise an interlocking system 961, wherein the top part 913 of the flooring system support unit 915 is formed so one side 963 of the top part 913 can be fitted under an adjacent side 995 of the top part 913 of another flooring system support unit 915, hereby attaching the flooring system support units 915 to each other in a side to side manor, hereby obtaining an extended even flooring support surface 911 extending from one top part 913 to another. The bottom part 921 in this particular embodiment also comprises a similar interlocking system 961. In this embodiment, the insert 949 is detachable from the bottom part 921 and is shaped in the form of a rounded triangular shape.

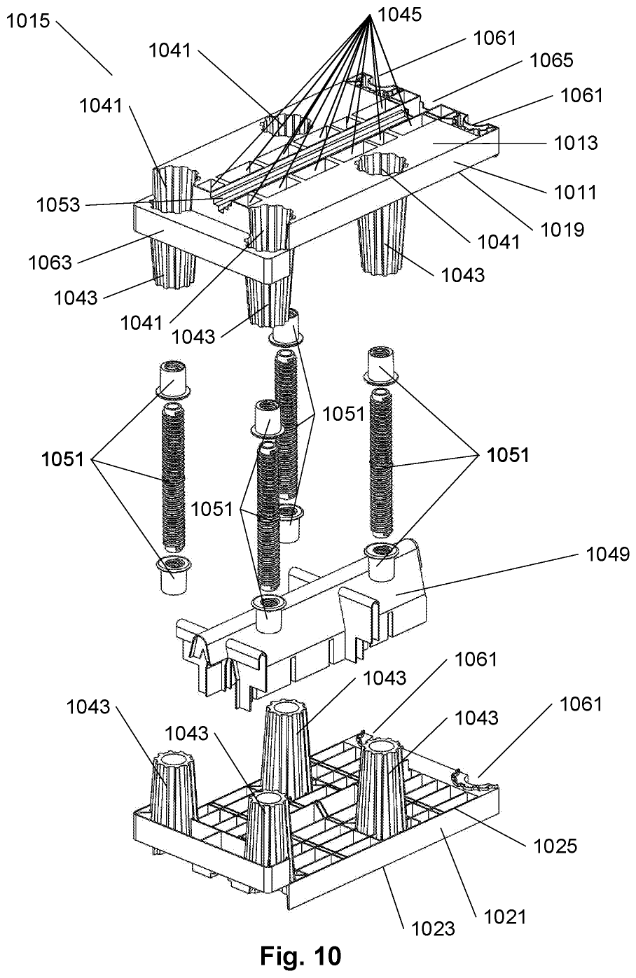

FIG. 10 shows an exploded view of the embodiment as disclosed in FIG. 9. This gives a better view of the adjustment system 1051 used between the interconnecting half-legs 1043.

When describing the embodiments, the combinations and permutations of all possible embodiments have not been explicitly described. Nevertheless, the mere fact that certain measures are recited in mutually different dependent claims or described in different embodiments does not indicate that a combination of these measures cannot be used to advantage. The present invention envisage all possible combinations and permutations of the described embodiments.

The person skilled in the art realizes that the present invention is not limited to the preferred embodiments described above. The person skilled in the art further realizes that modifications and variations are possible within the scope of the appended claims. Additionally, variations to the disclosed embodiments can be understood and effected by the skilled person in practicing the claimed invention, from a study of the drawings, the disclosure, and the appended claims.

### REFERENCES

101 —Pig
103—Piggery
105—Pigsty
107—Manure channel
109, 509, 609, 709—Grating
111, 211, 311, 411, 511, 611, 711, 811, 911, 1011—Flooring support surface
113, 213, 313, 413, 513, 613, 713, 813, 913, 1013—Top part
115, 215, 315, 415, 515, 615, 715, 815, 915, 1015—Flooring system support unit
117—Concrete pillar
119, 219, 319, 419, 519, 619, 719, 819, 919, 1019—Opposing underside
121, 221, 321, 421, 521, 621, 721, 821, 921, 1021—Bottom part
123, 223, 323, 423, 523, 623, 723, 823, 923, 1023—Support side
125, 225, 325, 425, 525, 625, 725, 825, 925, 1025—Opposing topside
127—Middle part
129, 229, 329, 429, 529, 629, 729, 829, 929—Interconnecting support leg
131—Watertight manure channel membrane
133—Compressed bed of sand
135—Concrete floor
137—Vacuum manure system/piping
139, 639, 739—Wall element
241, 341, 441, 841, 941, 1041—Hole
243, 343, 443, 543, 643, 743, 843, 943, 1043—Interconnecting half-leg
245, 345, 445, 545, 645, 745, 845, 945, 1045—Through-opening
247, 447, 547, 647, 747—Furrow
249, 349, 449, 549, 649, 749, 849, 949, 1049—Insert
251, 351, 451, 551, 651, 751, 851, 951, 1051—Adjustment system
253, 353, 553, 653, 753, 853, 953, 1053—Means for attaching
355—Protrusion
457—Means for attaching
459—Flange
961—Interlocking system
963—One side
965—Adjacent side

1. A modular flooring system for construction of a piggery with a pigsty with an underlying manure channel, wherein the modular flooring system comprises:
one or more flooring system support units each comprising:
a top part comprising:
a flooring support surface; and
an opposing underside;
a bottom part comprising:
a support side;
an opposing topside; and
a middle part comprising at least two interconnecting support legs extending between, and connecting the top part with the bottom part, wherein the support side of the bottom part is placed directly on a supporting floor surface;
one or more gratings mounted on the top part of the one or more flooring system support units, wherein each of the one or more gratings is configured for providing a support floor for carrying one or more pigs; and
one or more watertight manure channel membranes configured to ensure imperviousness of sides, a bottom, and/or ends of the one or more manure channels defined in a space between the one or more watertight manure channel membranes and the one or more gratings.

2. The modular flooring system according to claim 1, wherein the flooring support surface of the top part of each of the one or more flooring system support units comprises furrows or recesses and/or a protrusion at or near a side on the flooring support surface for mounting the one or more gratings.

3. The modular flooring system according to claim 1, wherein the one or more flooring system support units are made of injection molded plastic.

4. The modular flooring system according to claim 1, wherein each of the at least two interconnecting support legs comprises an adjustment system for adjusting a distance between the opposing underside of the top part with the opposing topside of the bottom part.

5. The modular flooring system according to claim 1, wherein the top part of each of the one or more flooring system support units further comprises one or more through-openings extending entirely through the top part from the flooring support surface to the opposing underside.

6. The modular flooring system according to claim 1, wherein the top part of each of the one or more flooring system support units further comprises means for attaching one or more wall elements designed to constitute one or more partition walls of the pigsty.

7. The modular flooring system according to claim 1, wherein the bottom part further comprises an insert attached to the opposing topside of the bottom part and wherein the insert extends outwards from the opposing topside of the bottom part.

8. The modular flooring system according to claim 1, further comprising:
wherein the top part and/or the bottom part of one of the one or more flooring system support units comprises an interlocking system so that the one of the one or more flooring system support units is attached to a second one of the one or more flooring system support units in a side-by-side manner so as to obtain an extended, even flooring support surface extending from the top part of the one of the one or more flooring system support units to the top part of second one of the one or more flooring system support units.

9. The modular flooring system according to claim 1, wherein the support side of the bottom part has a two-dimensional surface area, of an outer surface in direct contact with the supporting floor surface at least twice a total two-dimensional surface area of the at least two interconnecting support legs if the two-dimensional surface area of the at least two interconnecting support legs is measured where the total two dimensional surface area is largest.

10. The modular flooring system according to claim 1, wherein each of the at least two interconnecting support legs is divided into two substantially similar sized half-legs hereby obtaining at least four interconnecting half-legs, and wherein each of the one or more flooring system support units comprises:
a first piece comprising the top part and at least two of the at least four interconnecting half-legs; and
a second piece comprising the bottom part and at least another two of the at least four interconnecting half-legs.

11. The modular flooring system according to claim 10, wherein the first piece comprises holes in the top part corresponding to shapes of the at least two of the at least four interconnecting half-legs so the first piece is stackable with a first piece of another one of the one or more flooring system support units, and wherein the second piece comprises holes in the bottom part corresponding to shapes of the another two of the at least four interconnecting half-legs so the second piece is stackable with a second piece of the another one of the one or more flooring system support units.

12. The modular flooring system according to claim 11, wherein the first piece and the second piece are of similar shape and size.

13. The modular flooring system according to claim 12, wherein the first piece and the second piece are stackable with each other.

14. A flooring system support unit in a piggery with a pigsty with an underlying manure channel, wherein the flooring system support unit comprises:
a top part comprising:
a flooring support surface; and
an opposing underside;
a bottom part comprising:
a support side;
an opposing topside; and
a middle part comprising at least two interconnecting support legs extending between, and connecting the top part with the bottom part, wherein the support side of the bottom part is placed directly on a supporting floor surface.

15. A piggery comprising:
a modular flooring system comprising:
one or more flooring system support units each comprising:
a top part comprising:
a flooring support surface; and
an opposing underside;
a bottom part comprising:
a support side; and
an opposing topside; and
a middle part comprising at least two interconnecting support legs extending between, and connecting the top part with the bottom part, wherein the support side of the bottom part is placed directly on a supporting floor surface;
one or more gratings mounted on the top part of the one or more flooring system support units, wherein each of the one or more gratings is configured for providing a support floor for carrying one or more pigs; and
one or more-watertight manure channel membranes configured to ensure imperviousness of sides, a bottom, and/or ends of one or more manure channels defined in a space between the one or more watertight manure channel membranes and the one or more gratings; and
an animal standing on the grating.

16. (canceled)

17. The modular flooring system according to claim 1, wherein the supporting floor surface is selected from the group consisting of: a concrete floor, a compressed bed of sand on a concrete floor, and a watertight manure channel membrane on a compressed bed of sand, and a watertight manure channel membrane on a compressed bed of sand that is on a concrete floor.

18. The flooring system support unit according to claim 14, wherein the supporting floor surface is selected from the group consisting of: a concrete floor, a compressed bed of sand on a concrete floor, and a watertight manure channel membrane on a compressed bed of sand, and a watertight manure channel membrane on a compressed bed of sand that is on a concrete floor.

19. The piggery according to claim 15, wherein the supporting floor surface is selected from the group consisting of: a concrete floor, a compressed bed of sand on a concrete floor, and a watertight manure channel membrane on a compressed bed of sand, and a watertight manure channel membrane on a compressed bed of sand that is on a concrete floor.

20. The piggery according to claim 15, further comprising wall elements attached to the top part, wherein the animal is positioned between the wall elements.

21. The piggery according to claim 15, wherein the animal is a pig.

22. The piggery according to claim 15, wherein manure of the animal is present within the manure channel.
